(19) United States
(12) Patent Application Publication
(10) Pub. No.: US 2026/0134736 A1
(43) Pub. Date: May 14, 2026

(54) CONNECTOR CARRIER FOR ELECTRONIC DEVICE KIOSK

(71) Applicant: ecoATM, LLC, San Diego, CA (US)

(72) Inventors: Babak Forutanpour, San Diego, CA (US); Ted Ray Gooding, San Diego, CA (US)

(21) Appl. No.: 19/377,645

(22) Filed: Nov. 3, 2025

Related U.S. Application Data
(63) Continuation of application No. 17/445,178, filed on Aug. 16, 2021, now Pat. No. 12,475,756.
(60) Provisional application No. 63/066,794, filed on Aug. 17, 2020.

(51) Int. Cl. G07F 11/00; G06Q 10/30; G06Q 20/18; G07F 7/00; G07F 9/00; G07F 9/02; G07F 17/00; H02J 7/02; H02J 50/80; H04B 1/3877

(52) U.S. Cl. CPC G07F 11/005; G06Q 10/30; G06Q 20/18; G07F 7/005; G07F 9/001; G07F 9/002; G07F 9/0235; G07F 17/0014; H04B 1/3877; H02J 7/02; H02J 50/80

(57) ABSTRACT

Various embodiments of kiosks for purchasing mobile phones and other mobile electronic devices from users are disclosed herein. In some embodiments, the kiosks include an apparatus to position an electrical connector for connection to a mobile device. This apparatus enables the kiosk to connect to the mobile device to electrically inspect the mobile device, and the associated electrical connectors and cables are not subjected to repeated pulling and other rough handling that can lead to premature wear and tear. Accordingly, use of connector carriers configured in accordance with the present technology can lead to longer connector/cable service life, reduced maintenance, and greater kiosk up-time. In some embodiments, the apparatus can include a camshaft having one or more cam lobes positioned to act against one or more cam followers, e.g., carrying one or more electrical connectors.

### CROSS-REFERENCE TO RELATED APPLICATIONS

This application is a continuation of U.S. patent application Ser. No. 17/445,178, filed Aug. 16, 2021, which claims the benefit of U.S. Provisional Patent Application No. 63/066,794, filed Aug. 17, 2020, the entirety of which are incorporated by reference herein.

### TECHNICAL FIELD

The present disclosure is generally related to consumer operated kiosks for purchasing mobile phones and other mobile electronic devices from users.

### BACKGROUND

There are more mobile phones in use now than there are people on the planet. The rapid growth of mobile phones is due in part to the rapid pace at which they evolve. Because of the rapid pace of development, a relatively high percentage of mobile phones are replaced every year as consumers continually upgrade to obtain the latest features or a better operating plan. According to the U.S. Environmental Protection Agency, the U.S. alone disposes of over 370 million mobile phones, PDAs, tablets, and other electronic devices every year. Millions of other outdated or broken mobile phones are simply tossed into junk drawers or otherwise kept until a suitable disposal solution arises.

Although many mobile phone retailers and cell carrier stores now offer mobile phone trade-in or buyback programs, many old phones still end up in landfills or are improperly disassembled and disposed of in developing countries. Unfortunately, mobile phones and similar devices typically contain substances that can be harmful to the environment, such as arsenic, lithium, cadmium, copper, lead, mercury and zinc. If not properly disposed of, these toxic substances can seep into groundwater from decomposing landfills and contaminate the soil with potentially harmful consequences for humans and the environment.

As an alternative to retailer trade-in or buyback programs, consumers can recycle and/or sell their used mobile phones using self-service kiosks located in malls, retail stores, or other publicly accessible areas. Such kiosks are operated by ecoATM, LLC, the assignee of the present application, and can be configured to receive mobile phones from different manufactures and with different electrical connector configurations.

### BRIEF DESCRIPTION OF THE DRAWINGS

FIG. 1 is an isometric view of a consumer operated kiosk for purchasing mobile electronic devices from users, configured in accordance with embodiments of the present technology.

FIGS. 2A-2C are a series of enlarged isometric views illustrating structures and functions associated with an inspection area of the kiosk of FIG. 1, configured in accordance with embodiments of the present technology.

FIG. 3 is a right rear isometric view of an inspection tray assembly configured in accordance with embodiments of the present technology.

FIG. 4 is a right rear isometric view of an electrical connector carrier assembly configured in accordance with embodiments of the present technology.

FIGS. 5A and 5B are right rear and right front isometric views, respectively, of certain aspects the electrical connector carrier assembly of FIG. 4, with other aspects omitted for the purpose of clarity.

FIG. 5C is a right front isometric view of another electrical connector carrier assembly configured in accordance with embodiments of the present technology.

FIG. 6 is an isometric view of the camshaft and the cam lobes of FIGS. 5A-5C.

FIGS. 7A and 7B are right front and right rear isometric views, respectively, of the cam follower of FIGS. 5A-5C.

FIGS. 8A and 8B are side views illustrating operation of certain aspects the electrical connector carrier assembly of FIG. 4, with other aspects of the carrier assembly omitted for the purpose of clarity.

FIGS. 9A-9C are a series of side views illustrating operation of certain aspects the electrical connector carrier assembly of FIG. 4, with other aspects of the carrier assembly omitted for the purpose of clarity.

### DETAILED DESCRIPTION

The following disclosure describes various embodiments of devices, systems, and associated methods for providing an appropriate electrical connector for connection to, e.g., a mobile phone or other electronic device in a consumer operated kiosk. As described in greater detail below, in some embodiments, the kiosk determines the appropriate connector for connecting to a mobile phone submitted by a user, and a connector carrier configured in accordance with the present technology automatically presents the appropriate connector in a position in which the user can easily connect their phone to the connector. When connected to the mobile phone, the electrical connector can be used to inspect and evaluate the mobile phone, e.g., for recycling. In some embodiments, connector carriers configured in accordance with the present technology can include a camshaft having one or more cam lobes positioned to act on one or more cam followers. Each of the cam followers can carry one of a plurality of different mobile phone connectors. In contrast to conventional connector carriers in which the connectors and the associated cables are manually extracted from the carrier for manual connection to a mobile device, kiosks including connector carriers configured in accordance with embodiments of the present technology can identify an appropriate electrical connector, identify a cam lobe and/or a cam follower associated with the appropriate electrical connector, and rotate a camshaft to drive the identified cam lobe into the corresponding cam follower to position the appropriate electrical connector for connection with the mobile device. After the electrical inspection, the kiosk can automatically disconnect the connector from the mobile device. As a result, the connectors and associated cables are not subjected to repeated pulling and other rough handling that can lead to premature wear and tear. Accordingly, use of connector carriers configured in accordance with the present technology can lead to longer connector/cable service life, reduced maintenance, and greater kiosk up-time.

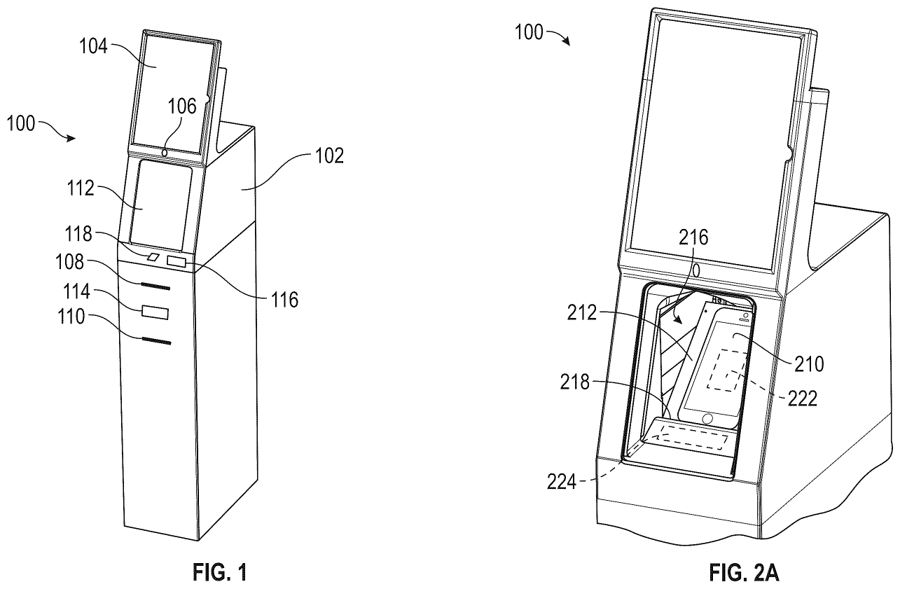

Certain details are set forth in the following description and in FIGS. 1-9C to provide a thorough understanding of various embodiments of the present technology. In other instances, well-known structures, materials, operations and/or systems often associated with smartphones and other handheld mobile electronic devices, consumer electronic devices, computer hardware, software, and network systems, etc. are not shown or described in detail in the following disclosure to avoid unnecessarily obscuring the description of the various embodiments of the present technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the present technology. Accordingly, other embodiments can have other details, dimensions, angles and features without departing from the spirit or scope of the present disclosure. In addition, those of ordinary skill in the art will appreciate that further embodiments of the present technology can be practiced without several of the details described below. In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a consumer operated kiosk 100 for purchasing, recycling, or otherwise processing mobile phones and other electronic devices from users, configured in accordance with embodiments of the present technology. The kiosk 100 includes an enclosure or housing 102 that supports a display screen 104 positioned above an inspection area access door 112. The access door 112 can be formed from, e.g., one or more polymers (e.g., polyethylene, polycarbonate, etc.), glass, etc. that can be transparent, opaque or solid. The housing 102 can be manufactured from, for example, sheet metal, plastic panels, etc. in a conventional manner.

A plurality of user interface devices are provided on a front portion of the housing 102 for providing instructions and other information to users, and/or for receiving user inputs and other information from users. For example, in some embodiments, the display screen 104 can include a liquid crystal display (LCD) or a light emitting diode (LED) display screen, a projected display (such as a heads-up display or a head-mounted device), and so on, for providing information, prompts, etc. to users. The display screen 104 can also display graphical user interfaces (GUIs), including touch screens, for receiving user input and responses to displayed prompts. Additionally, or alternatively, the kiosk 100 can include a separate keyboard or keypad for receiving user inputs. The kiosk 100 can also include an ID reader or scanner 108 (e.g., a driver's license scanner), a fingerprint scanner 118, and one or more external cameras 106 (e.g., digital still and/or video cameras). The kiosk 100 can additionally include output devices such as a label printer (e.g., a barcode label printer) having an outlet 116, a payment (e.g., cash, voucher, coupon, etc.) dispenser having an outlet 110, and/or a receipt dispenser having an outlet 114. Although not identified in FIG. 1, the kiosk 100 can further include, e.g., a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), as well as other user input and/or output devices. Additionally, the kiosk 100 can also include a barcode reader (for reading, e.g., a barcode displayed on a mobile device), a QR code reader (for reading, e.g., a QR displayed on a mobile device), a package or bag dispenser (e.g., a shipping package dispenser), a digital signature pad, etc. The user interface devices described above are representative of such devices that can be included with some embodiments the kiosk 100. Depending on the particular use case or commercial application, other embodiments of the kiosks disclosed herein can include other devices, or one or more of the above devices may be omitted. Accordingly, embodiments of the kiosk 100 are not limited to the type or arrangement of user interface devices described above.

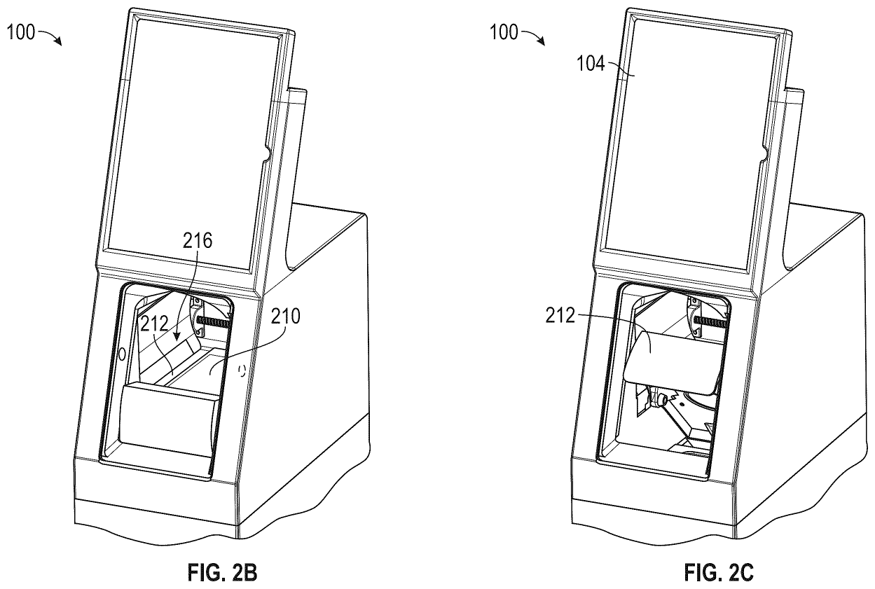

FIGS. 2A-2C are a series of enlarged isometric views illustrating structures and functions associated with an inspection area 216 of the kiosk 100. Referring first to FIG. 2A, in some embodiments, a user wishing to sell a used electronic device (e.g., a mobile phone 210) via the kiosk 100 would first approach the kiosk 100 and follow prompts displayed on the display screen 104. Such prompts, for example, may ask the user what type of phone they wish to sell, who the carrier is, etc. To begin the process, the access door 112 (FIG. 1) retracts upwardly behind the display screen 104 to expose the inspection area 216. The inspection area 216 includes an inspection tray 212 having a shelf 218. The user is instructed (via, e.g., prompts on the display screen 104) to position the mobile phone 210 in the inspection area on the shelf 218 as shown in FIG. 2A. The mobile phone 210 is positioned on the inspection tray 212 so that a display of the mobile phone 210 is facing outwardly toward the user with the electrical connector receptacle or port facing downwardly toward the shelf 218. In some embodiments the kiosk 100 includes an electrical connector carrier assembly 224 (shown schematically in FIG. 2A) that, as described in greater detail below, automatically extends an appropriate electrical connector (not shown) outwardly from the shelf 218. As described in greater detail below, by positioning the mobile phone 210 on the shelf 218 in this manner, the user can easily connect the mobile phone 210 to the electrical connector. The appropriate electrical connector can be determined by the kiosk 100 in response to, for example, user responses to questions regarding the type of phone presented on the display screen 104. After the user has properly positioned the mobile phone 210 on the inspection tray 212 and the phone is powered on, the user can interact with the touch screen of the mobile phone 210 in response to prompts displayed on the display screen 104. As described in greater detail below, these interactions can cause the mobile phone 210 to display information about the phone (e.g., model identification, serial number, etc.) that can be captured by a camera (not shown) in the inspection area 216 and used by the kiosk to facilitate the phone inspection process, provide a price quote, etc. For example, in some embodiments the kiosk 100 can prompt or instruct the user to dial “*#06#” on the mobile phone 210 (via, e.g., the display screen of the mobile phone 210), which can bring up information about the mobile phone 210, such as the IMEI number.

In some embodiments, the kiosk 100 can also include a wireless charger 222 positioned in relatively close proximity to the mobile phone 210 when the phone is positioned on the inspection tray as shown in FIG. 2A. For example, in the illustrated embodiment, the wireless charger 222 is mounted to the backside of the inspection tray 212. The wireless charger 222 can be, for example, a “Qi wireless charger” that functions in accordance with the Qi open interface standard that defines wireless power transfer using inductive charging over distances of up to, e.g., about 1.6 inches. In operation, the wireless charger 222 can provide a quick charge to the mobile phone 210 if it is placed on the inspection tray 212 without power. Additionally, in operation the wireless charger 222 receives certain information about the mobile phone (e.g., make, model, a unique 32-bit identifier associated with the phone, Qi standard, etc.) as part of the charging process. This information can be transmitted to the kiosk processor and used to, for example, identify the correct electrical connector (e.g., a USB-C or Lightning connector) to present to the user on the inspection tray shelf 218.

Turning next to FIG. 2B, the inspection tray 212 can be configured to rotate rearwardly into a horizontal position so that the mobile phone 210 is facing upwardly in the inspection area 216. Although, in some embodiments, the access door 112 (FIG. 1) would normally be closed during this stage of kiosk operation, the access door 112 is not shown in FIG. 2B (or FIG. 2C) to better illustrate operation of the inspection tray 212 and the inspection area 216. With the mobile phone 210 in this position (or in the prior position illustrated in FIG. 2A), the kiosk 100 performs an electrical inspection of the mobile phone 210 via the electrical connector to identify the phone and further evaluate the condition of the phone, as well as specific component and operating parameters such as memory, carrier, etc. For example, in some embodiments, the kiosk 100 (e.g., a kiosk CPU or other processing device) can query the mobile phone 210 (by using, e.g., an operating system API) to obtain characteristic information about the mobile phone 210, which can include device identification, make, model, configuration, and/or a unique identifier (e.g., an IMEI number, an MEID, and/or any other suitable unique identifier). In some embodiments, the characteristic information further includes device functionality, including hardware/software configuration, charging capability, memory capacity, etc. In some embodiments, the electrical analysis includes evaluating the condition and/or functionality of the charging circuit of the electronic device. In some embodiments, the kiosk 100 performs the electrical analysis using one or more of the methods and/or systems described in detail in the patents and patent applications identified herein and incorporated herein by reference in their entireties.

In addition to performing an electrical inspection, the kiosk 100 can also perform a visual inspection of the mobile phone 210 using one or more cameras (not shown) positioned in the inspection area 216. In some embodiments, the visual inspection includes a 3D visual analysis (of, e.g., the shape and/or size of the phone) to confirm the identification of the mobile phone 210 (e.g., make and model) and/or to evaluate or assess the condition and/or function of the mobile phone 210 and/or its various components and systems. The visual analysis can also include an inspection of the mobile phone 210 for cracks or other damage to the display screen (LCD), as well as cracks on other portions of the mobile phone. In some embodiments, the visual inspection can include performing optical character recognition (OCR) to identify printed or displayed patterns, codes, and/or text, and comparing characteristics of the patterns, codes, and/or text (e.g., layout, size, font, color, etc.) to templates to determine the presence of device identifiers such as model number, serial number, IMEI number, etc. In some embodiments, the visual analysis includes one or more of the methods and/or systems described in detail in the patents and patent applications identified herein and incorporated herein by reference in their entireties.

After the mobile phone 210 has been fully evaluated and the kiosk 100 has determined a purchase price, the purchase price can be offered to the user via the display screen 104. If the user accepts the purchase price offer, the access door 112 remains closed and the inspection tray 212 rotates further rearwardly as shown in FIG. 2C, so that the mobile phone 210 can slide off of the inspection tray 212 and into a storage bin (not shown). (Although the access door 112 would normally be closed during this stage of operation, the access door 112 is omitted from FIG. 2C for purposes of illustrative clarity.) The kiosk 100 can then provide payment of the purchase price to the user. In some embodiments, payment can be made in the form of cash dispensed from the payment outlet 110. In other embodiments, the user can receive remuneration for the mobile phone 210 in various other useful ways. For example, the user can be paid via a redeemable cash voucher, a coupon, an e-certificate, a prepaid card, etc. that is dispensed from the kiosk 100; or via a gift code, redeemable voucher, coupon, e-certificate, etc., that is sent to the user via email, text, or other form of electronic message. Additionally, in some embodiments the user can be paid via a wired or wireless monetary (e.g., cash) deposit to an electronic account (e.g., a bank account, credit account, loyalty account, online commerce account, mobile wallet, etc.) via, e.g., PayPal, Venmo, etc., or with cryptocurrency (e.g., Bitcoin), etc.

Alternatively, if the user declines the purchase price offer, or if the user's identity cannot be verified or the kiosk 100 otherwise determines that the transaction presents a fraud risk, the transaction can be declined and the mobile phone 210 returned to the user. More specifically, the inspection tray 212 rotates forwardly to the position illustrated in FIG. 2A and the access door 112 opens so that the user can retrieve the mobile phone 210 from the kiosk 100.

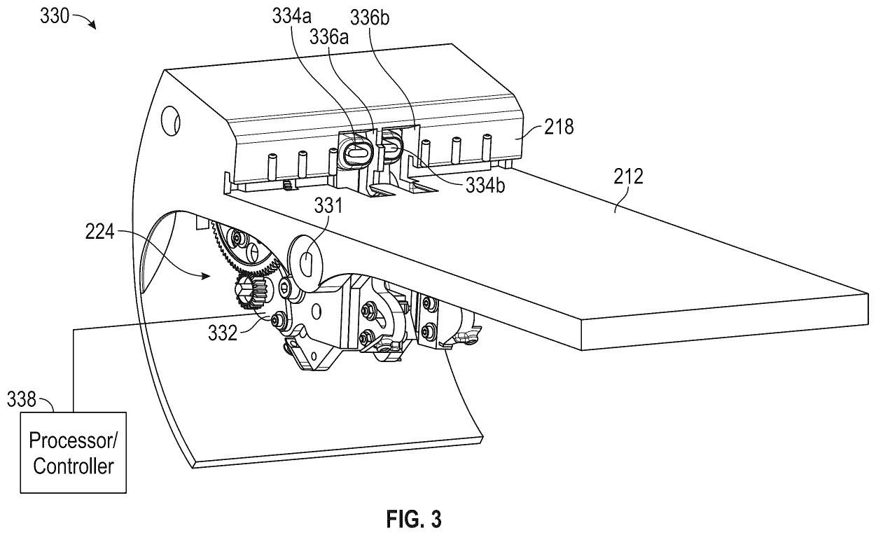

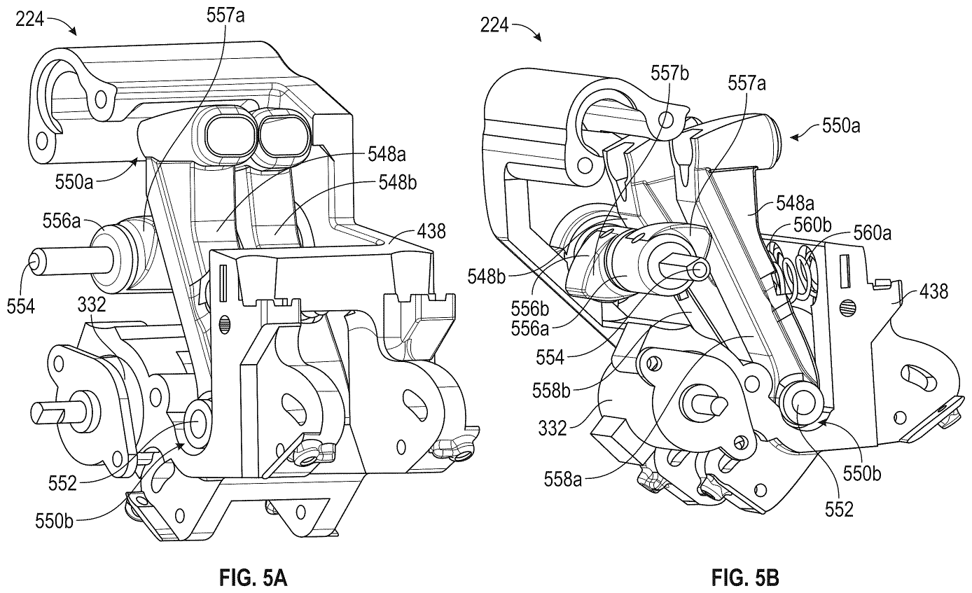

FIG. 3 is a right rear isometric view of an inspection tray assembly 330 configured in accordance with embodiments of the present technology. The inspection tray assembly 330 can include the inspection tray 212 and the electrical connector carrier assembly 224, which can alternatively be referred to as “the connector carrier assembly 224” and/or the “carrier assembly 224.” In the illustrated embodiment, the carrier assembly 224 is mounted to the underside of the inspection tray 212 and moves with the inspection tray 212 as it pivots about, e.g., an inspection tray bore 331 and between the three positions illustrated in FIGS. 2A-2C. The connector carrier assembly 224 includes an electric motor 332 (e.g., a stepper motor) operably coupled to a camshaft (described below with respect to FIGS. 5A-5C). The camshaft includes one or more cam lobes that are each operably positioned to move a corresponding one of a plurality of mobile device electrical connectors 334a-b (e.g., USB connectors, Android and iOS connectors, etc.). Each of the electrical connectors can be positioned in or near a corresponding opening 336a-b in the shelf 218 of the inspection tray 212. In the illustrated embodiment, for example, the inspection tray assembly 330 includes a first opening 336a aligned with a first electrical connector 334a and a second opening 336b aligned with a second electrical connector 334b. In operation, a kiosk processor and/or controller 338 can activate the motor 332, which in turn can rotate the camshaft so that one of the lobes selectively drives the desired electrical connector (e.g., first electrical connector 334a) outwardly through the corresponding opening 336a, while the other electrical connector(s) (e.g., second electrical connector 334b) remain retracted in the corresponding opening(s) (e.g., second opening 336b). With the desired electrical connector in this position, the user can easily connect their mobile phone to the correct connector when placing their mobile phone on the shelf 218, as illustrated above with reference to FIG. 2A.

With continued reference to FIG. 3, the camshaft configuration of the carrier assembly 224 enables the electrical connectors 334a-b to be compactly arranged in the inspection tray assembly 330. In some embodiments, the correct/appropriate electrical connector is selected based on the make and model of phone that the user has identified, e.g., via the display screen 104 (FIG. 1) that they wish to sell. Once the mobile phone has been electrically inspected via the selected connector, the motor 332 can rotate the camshaft to drive the selected connector to return back through the opening to automatically disconnect the connector from the mobile phone.

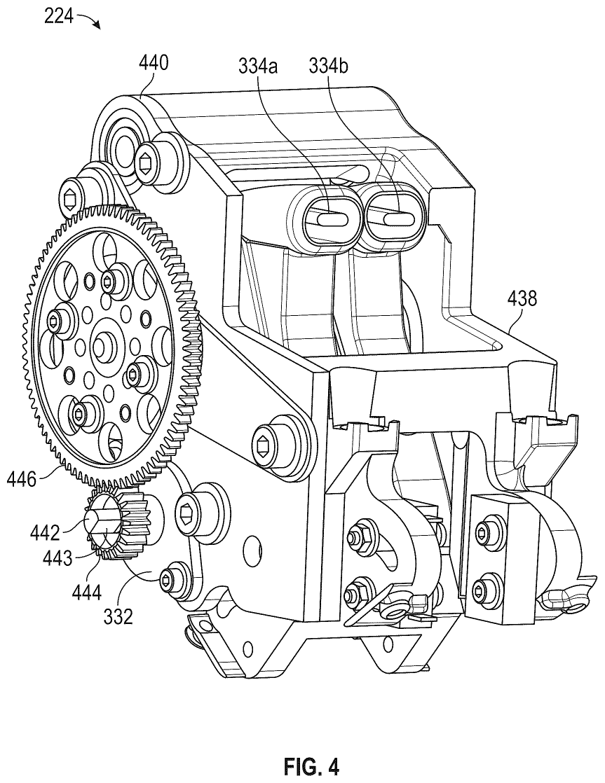

FIG. 4 is a right rear isometric view of the electrical connector carrier assembly 224, configured in accordance with embodiments of the present technology. The carrier assembly 224 can include a housing or support structure 438 having a plate or plate portion 440. In some embodiments, the support structure 438 is connected to the inspection tray 212 and moves therewith during operation of the kiosk 100. The motor 332 can be coupled or otherwise secured to the housing 438, and can include a motor or output shaft 442 operably coupled to a first gear 444. In the illustrated embodiment, for example, the motor shaft 442 is keyed and/or includes a flat or engagement surface 443 that engages the first gear 444, e.g., to drive rotation thereof. The carrier assembly 224 can further include a second gear 446 operably coupled to the camshaft (not shown). In the illustrated embodiment, the first gear 444 is a spur gear and/or a drive gear and the second gear 446 is a spur gear and/or a driven gear such that, in operation, the motor 332 can rotate the first gear 444 to drive rotation of the second gear 446, e.g., to rotate the camshaft and selectively drive the desired electrical connector 334a-b outwardly, as described previously and with reference to FIG. 3.

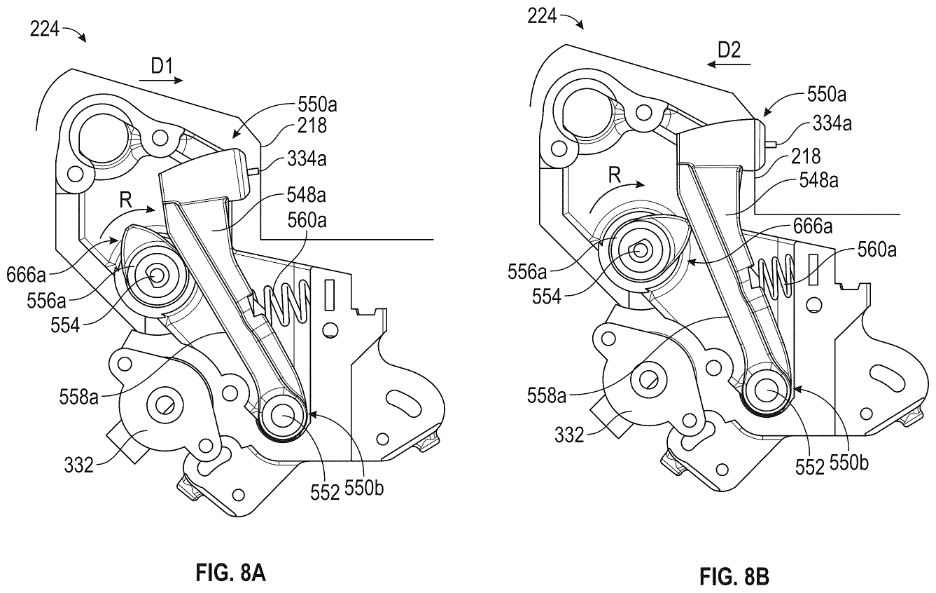

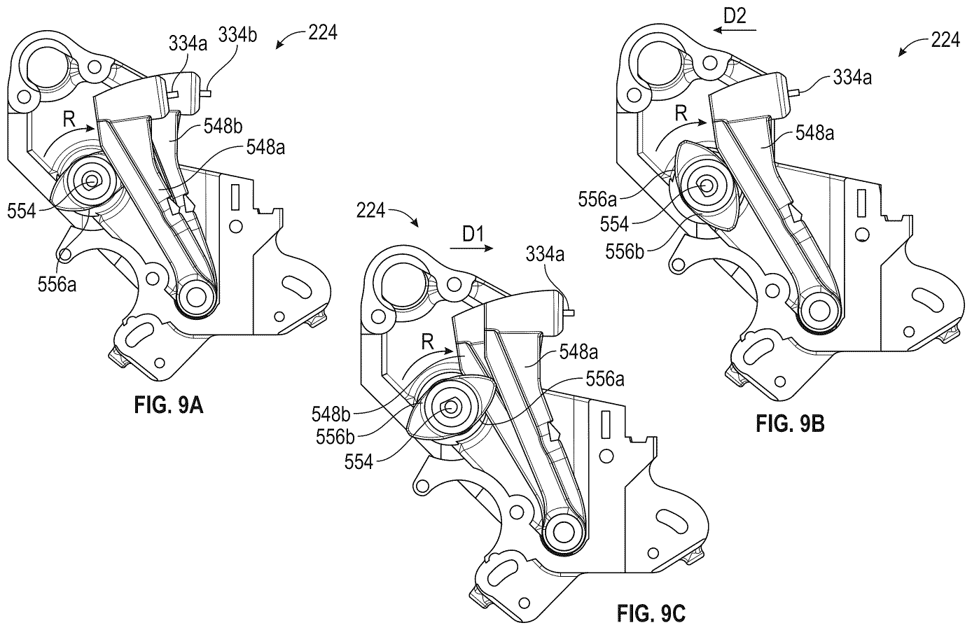

FIGS. 5A and 5B are right rear and right front isometric views, respectively, of certain aspects the electrical connector carrier assembly 224 of FIG. 4, with other aspects omitted for the purpose of clarity. The carrier assembly 224 can include one or more cam followers movably coupled to the housing 438. In the illustrated embodiment, for example, the carrier assembly 224 includes a first cam follower 548a and a second cam follower 548b (“the cam followers 548”). Each of the cam followers 548 can have a first or distal end portion 550a and a second or proximal end portion 550b opposite the first end portion. In FIGS. 5A and 5B, the first and second end portions 550a-b are only shown for the first cam follower 548a for the purpose of clarity; however, it can be appreciated that the second cam follower 548b can be configured generally similar to or the same as the first cam follower 548a (e.g., to also include first and second end portions). In the illustrated embodiment, the second end portion 550b is pivotably or rotatably coupled to the housing 438 via, e.g., a pivot shaft (not shown) received by a bore 552, such that first end portion 550a can pivot or rotate about the second end portion 550b. The first end portion 550a can include the electrical connector (illustrated and described below with respect to FIGS. 8A-9C).

The carrier assembly 224 can include a camshaft 554 having one or more cam lobes. Each of the cam lobes can be positioned to contact, drive, and/or otherwise correspond to one of the cam followers 548. In the illustrated embodiment, for example, the camshaft 554 includes a first cam lobe 556a that corresponds to the first cam follower 548a and a second cam lobe 556b that corresponds to the second cam follower 548b (“the cam lobes 556”). Each of the cam lobes 556 can include a protrusion 557a-b or other rotationally asymmetric feature extending away from the camshaft 554. The camshaft 554 can be operably (e.g., rotatably, etc.) coupled to the housing 438 such that, as described previously, the motor 332 can drive rotation of the camshaft 554, e.g., about a longitudinal axis of the camshaft 554 (not shown). The rotation of the camshaft 554 can cause one or more of the cam lobes 556 to exert force onto one of the cam followers (e.g., via rotation of the protrusions 557 into contact with the cam followers). In the illustrated embodiment, for example, rotation of the cam shaft selectively causes the first cam lobe 556a to exert a force onto a first bearing surface 558a of the first cam follower 548a and causes the second cam lobe 556b to exert a force onto a second bearing surface 558b of the second cam follower 548b. As described in greater detail below, the interaction between the cam lobe(s) 556 and the bearing surface(s) 558 can move (e.g., pivot, translate, etc.) the cam follower(s) 548 relative to the housing 438, e.g., to drive the desired electrical connector to a position in which a user can easily connect their mobile phone to the electrical connector.

As illustrated in FIG. 5B. the carrier assembly 224 can include one or more biasing elements 560 operably coupled to the housing 438 and positioned to act against the cam followers 548. In the illustrated embodiment, for example, the carrier assembly 224 includes a first biasing element 560a positioned to act against the first cam follower 548a and a second biasing element 560b positioned to act against the second cam follower 548b. In the illustrated embodiment, the biasing element(s) 560 can be configured to bias the cam follower(s) 548 inwardly, e.g., to and/or toward from the camshaft 554 and away from the extended position in which the electrical connector can be connected to the mobile phone. In such embodiments, the biasing element(s) 560 can be configured to automatically disconnect the electrical connector from the mobile phone. The biasing element(s) 560 can include one or more compression springs, tension springs, torsion springs, and/or any other suitable biasing element. The biasing element(s) 560 can have sufficient tension and/or spring constant to ensure that the biasing force provided by the biasing element(s) 560 fully disconnects the electrical connector from the mobile phone. It can be appreciated that, in other embodiments, the carrier assembly 224 can be configured to operate at least partially in reverse, e.g., such that one or more of the biasing element(s) 560 can be configured to bias the cam follower(s) 548 outwardly, e.g., to and/or toward the extended position in which the electrical connector can be connected to the mobile phone and the camshaft 554 and cam lobe(s) 556 can be configured to drive the cam follower(s) 548 inwardly, e.g., away from the extended position.

With continued reference to FIGS. 5A and 5B, in some embodiments the carrier assembly 224 can include one or more sensors or sensing elements (not shown) operably coupled to one or more elements of the carrier assembly 224. Each of the one or more sensing elements can be operably coupled to and/or positioned to sense or determine the position and/or orientation of the cam followers 548. In at least some embodiments, for example, the carrier assembly 224 includes a first sensing element positioned to sense the position of the first cam follower 548a and a second sensing element positioned to sense the position of the second cam follower 548a. Additionally, or alternatively, the carrier assembly 224 can include a third sensing element configured to sense the rotational position and/or orientation of the camshaft 554 and/or the cam lobes 556. Each of the sensing elements can be communicatively coupled to the processor 338, such that, based at least in part on readings from the sensing elements, the processor 338 can determine an amount or angle to rotate the camshaft 554, e.g., to extend the appropriate electrical connector. For example, the motor 332 can be a stepper motor, and the processor 338 can determine a number of steps to rotate the stepper motor to position the appropriate electrical connector for connecting to the mobile phone 210. The sensing elements can include one or more switches, one or more pressure sensors, one or more optical sensors, one or more inductive sensors, one or more capacitive sensors, one or more rotation sensors, and/or any other suitable sensors and/or sensing elements. In some embodiments, the sensing elements are integrated switches configured to detect when the cam followers 548 are in extended positions (e.g., when the cables connectors are deployed). For example, the switches may be pressed when the cam followers 548 are in the deployed position.

FIG. 5C is a right front isometric view of an electrical connector carrier assembly 224a generally similar to or the same as the carrier assembly 224 of FIG. 4. However, in the illustrated embodiment, the carrier assembly 224a includes a single cam lobe 556a and a plurality of cam followers 548a-b. The camshaft 554 and/or the cam lobe 556 can be operably coupled to a motor 562 (shown schematically) using, e.g., one or more threads, gears, drive screws, and/or any other suitable mechanisms or techniques. The motor 562 can be operable to move or translate the cam lobe 556 and/or the camshaft 554, e.g., axially along the longitudinal axis of the camshaft 554 and between one or more positions. For example, in the illustrated embodiment, the motor 562 can be configured to move the cam lobe 556 and the camshaft 554 between a first position in which the cam lobe 556 is positioned to contact the first cam follower 548a, and a second position (not shown) where the cam lobe 556 is positioned to contact the second cam follower 548b. The carrier assembly 224a can be configured to at least partially prevent movement of one or more of the cam followers 548 toward the camshaft 554, e.g., to allow the camshaft 554 and/or the cam lobe 556 to move or translate between the one or more positions without or substantially without interference from the cam followers 548. For example, in some embodiments one or more portions of the camshaft 554 proximate the cam lobe 556 can have an increased diameter (not shown), e.g., generally similar to or the same as a minimum diameter of the cam lobe 556. Additionally, or alternatively, in some embodiments the carrier assembly 224 can include one or more barriers or stops (not shown) positioned to contact the cam followers 548, e.g., to prevent movement thereof beyond a predetermined position (e.g., a position in which the cam lobe 556 can slide behind the cam followers 548). Additionally, or alternatively, in some embodiments the bearing surfaces 558, the cam lobe 556, and/or the camshaft 554 can include one or more sloped, ramped, and/or curved surfaces (not shown), such that the cam lobe 556 and/or the camshaft 554 can slidably engage the bearing surfaces 558, e.g., to move or translate between the one or more positions.

The camshaft 554 can be movably coupled to the motor 562 by one or more drive elements 563 (shown schematically in FIG. 5C). The drive elements 563 can include threading, one or more gears, one or more pneumatic drivers, one or more hydraulic drive elements, one or more solenoids, one or more electromechanical drive elements, one or more magnetic drive elements, and/or any other suitable drive elements. The camshaft 554 can be configured to include the drive elements 563, e.g., to drive translational movement thereof via the motor 562. Accordingly, by moving the camshaft 554 and/or the cam lobe 556, the electrical connector carrier assembly 224a can use a single cam lobe 556 to select and drive one or more cam followers 548.

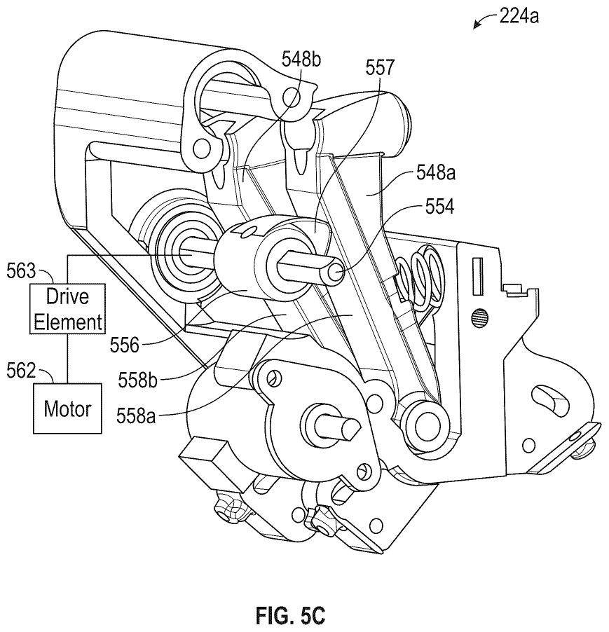

FIG. 6 is an isometric view of the camshaft 554 and the cam lobes 556 of FIGS. 5A-5B. The camshaft 554 can be keyed, can include an engagement surface or flat 664, or can otherwise be shaped to engage the cam lobes 556, e.g., so that the cam lobes 556 can rotate in concert with the camshaft 554. As described above, each of the cam lobes 556 can include a protrusion 557 or other structure extending away from the camshaft 554. The protrusions 557 can include a contact portion 666. In the illustrated embodiment, for example, the first cam lobe 556a has a first contact portion 666a and the second cam lobe 556b has a second contact portion 666b. In the illustrated embodiment, the first and second contact portions 666a-b extend in opposite directions such that the first and second cam lobes 556a-b are diametrically opposed. In other embodiments, the first and second cam lobes 556a-b can have any other suitable orientation, e.g., the first cam lobe 556a can be angled, aligned, etc., relative to the second cam lobe 556b.

The camshaft 554 and cam lobes 556 can be formed from one or more polymers, metals (e.g., aluminum, titanium, stainless steel, etc.), composites, and/or any other suitable material.

Although the camshaft 554 is depicted as having two cam lobes 556a-b in FIG. 6, in other embodiments the camshaft 554 can have more or fewer cam lobes. In at least some embodiments, for example, the camshaft 554 can include between one and nine cam lobes 556, such as at least one, two, three, four, five, six seven, eight, or any other suitable number of cam lobes 556. In some embodiments, the relative orientations of each of the cam lobes 556 can correspond to the number of cam lobes 556, e.g., such that each of the cam lobes 556 can have a same angle or angular orientation relative to adjacent cam lobes as the other cam lobes.

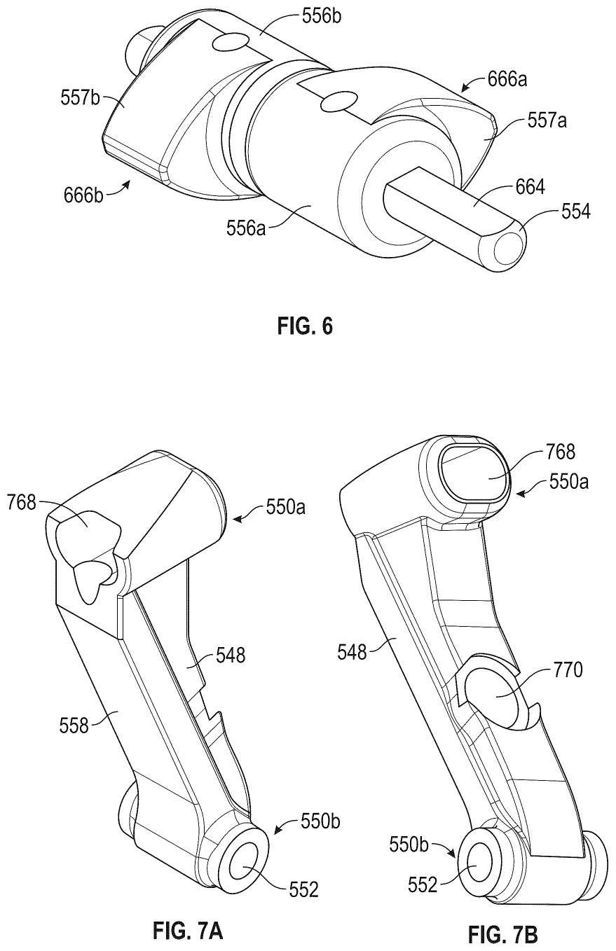

FIGS. 7A and 7B are right front and right rear isometric views, respectively, of the cam follower 548 of FIGS. 5A-5C. The first end portion 550a of the cam follower 548 can include a connector aperture or holder 768 configured to receive or hold at least a portion the electrical connector 334 (not shown). In some embodiments, the connector holder 768 can receive a shell or casing (not shown) that at least partially encapsulates or surrounds the electrical connector 334, e.g., such that the electrical connector 334 fits firmly and securely within the connector holder 768. In other embodiments, the electrical connector 334 (and/or a cord or power cable portion of the electrical connector 334) can be coupled to the cam follower 548 and/or the connector aperture 768 via, e.g., mechanical fasteners, adhesives, and/or any other suitable coupling process or technique. The cam follower 548 can further include a recess or biasing element mount 770 configured to receive an end or other portion of the biasing element 560. In the illustrated embodiment, the recess 770 is positioned between the first and second end portions 550a-b and opposite the bearing surface 558. In other embodiments, the recess 770 can have any other suitable position on the cam follower 548. In at least some embodiments, for example, the bearing surface 558 can include the recess 770. Additionally, or alternatively, in some embodiments the cam follower 548 can include a plurality of recesses 770. Additionally, or alternatively, in some embodiments the bore 552 can be positioned between the first and second end portions 550a-b, e.g., such that both the first and second end portions 550a-b rotate about the bore 552.

Although FIGS. 7A and 7B illustrate a cam follower 548 configured to pivot, e.g., about the second end portion 550b, it is further contemplated that in some embodiments the cam follower 548 can be configured to move or translate linearly, e.g., generally or substantially along an axis (e.g., a longitudinal axis) defined by the first and second end portions 550a-b. In such embodiments, the cam follower 548 can be referred to as a linear cam follower, the electrical connector carried by the linear cam follower can be at least partially aligned with the linear cam follower longitudinal axis, the cam lobe 556 can be positioned to act against the second end portion 550b, and the biasing element 560 can be positioned to act against the first end portion 550a. The cam follower 548 can be formed from one or more polymers, metals (e.g., aluminum, titanium, stainless steel, etc.), composites, and/or any other suitable material.

FIGS. 8A and 8B are side views illustrating operation of certain aspects the electrical connector carrier assembly 224 of FIG. 4, with other aspects of the carrier assembly 224 omitted for the purpose of clarity. Although described in the context of the first cam follower 548a and the first cam lobe 556a, it can be appreciated that a description of FIGS. 8A and 8B applies equally to the second cam follower 548b and the second cam lobe 556b, as well as any additional cam followers and/or cam lobes included in the carrier assembly 224.

As described previously, the motor 332 can be operably coupled to the camshaft 554, e.g., to drive rotation thereof. In the illustrated embodiment, the motor 332 is configured to drive rotation of the camshaft 554 in a clockwise direction R. In other embodiments, the motor 332 can be configured to drive rotation of the camshaft 554 in a counterclockwise direction, e.g., opposite the direction R. As the camshaft 554 rotates, the first cam lobe 556a rotates along with the camshaft 554, e.g., from the first position of FIG. 8A to and/or toward the second position shown in FIG. 8B. The rotation of the first cam lobe 556a can bring the first contact portion 666a into contact with the first bearing surface 558a. The contact between the first contact portion 666a and the first bearing surface 558a can rotate the first end portion 550a about the second end portion 550b to move the first end portion 550a outwardly, e.g., in the direction indicated by arrow D1.

When rotating the first cam follower 548a, the motor 332 can act against the first biasing element 560a. In the illustrated embodiment, for example, the first biasing element 560a is compressed as the first cam follower 548a pivots between the first position (FIG. 8A) and the second position (FIG. 8B). Referring to FIG. 8B, in the second position, the first end portion 550a of the first cam follower 548a can extend at least partially beyond the shelf 218, e.g., to position the first electrical connector 334a for connection to the mobile phone 210, as described previously. Additionally, it can be appreciated that further rotation of the camshaft 554, e.g., further clockwise rotation from the second position of FIG. 8B, can cause the first cam follower 548a to return from the second position to the first position. For example, further rotation of the camshaft 554 can drive the first contact portion 666a away from and/or out of contact with the first bearing surface 558a and allow the first biasing element 560a to act against the first cam follower 548a, pivoting the first end portion 550a about the second end portion 550b and moving the first end portion 550a in the direction D2. In some embodiments, the motion of the first end portion 550a in response to the first biasing element 560a can automatically disconnect the first electrical connector 334a from the mobile phone 210.

As described previously, in some embodiments the carrier assembly 224 includes one or more sensing elements configured to sense the position of the cam followers 548. Referring again to FIGS. 8A and 8B together, in some embodiments the carrier assembly 224 includes a first sensing element configured to sense whether the first cam follower 548a is in the first position (FIG. 8A) or the second position (FIG. 8B). For example, when in the second position, the first cam follower 548a can contact, press, or be otherwise detected by the first sensing element. Based on reading(s) from the sensing element(s), the kiosk 100 (e.g., the processor 338) can determine an operational status of the carrier assembly 224. For example, if the processor 338 sends a signal to the motor 332 to retract the first cam follower 548a (e.g., move from the second position to the first position) but a first reading from the first sensing element indicates that the first cam follower 548a is still in the second (extended or unretracted) position (e.g., if the first reading does not change in response to the signal to the motor 332), the processor 338 can determine, e.g., that first cam follower 548a is stuck in the second position, that the first biasing element 560a has not returned the first cam follower 548a to the first position, and/or that the first electrical connector 334a is still connected to the mobile phone 210.

In some embodiments, the carrier assembly 224 includes a second sensing element configured to sense a rotational position of the camshaft 554. As can be appreciated, because the rotation of the camshaft 554 can drive the first cam follower 548a between the first and second positions, the rotational position of the camshaft 554 can indicate whether the first cam follower 548a is in the first position or the second position. Accordingly, the above description of the first reading and first sensing element applies equally to a second reading from the second sensing element.

In some embodiments the carrier assembly includes a third sensing element configured to sense whether the electrical connector (e.g., the first electrical connector 334a) is connected to the mobile phone 210. The third sensing element can be operably coupled to the electrical connector, a cable or power cord of the electrical connector, and/or any other suitable element of the carrier assembly 224. Accordingly, the above description of the first reading and the first sensing element applies equally to a third reading from the third sensing element. In some embodiments, the processor 338 compares the first and/or second readings from the respective first and second sensing elements with the third reading from the third sensing element, e.g., to determine whether the electrical connector is connected to the mobile phone 210, etc.

FIGS. 9A-9C are a series of side views illustrating operation of certain aspects the electrical connector carrier assembly 224 of FIG. 4, with other aspects of the carrier assembly 224 omitted for the purpose of clarity. The discussion of FIGS. 8A and 8B applies equally to FIGS. 9A-9C. However, in the illustrated embodiment, the carrier assembly 224 includes two cam lobes (e.g., the first and second cam lobes 556a-b) and two cam followers (e.g., the first and second cam followers 548a-b). In FIGS. 9A-9C, the first and second cam lobes 556a-b are diametrically opposed, such that rotation of the camshaft 554 moves the first cam follower 548a or the second cam follower 548b, e.g., so only one of the cam followers 548a-b can be positioned to connect to the mobile phone 210 (not shown) at any given time. For example, in the first configuration illustrated in FIG. 9A, the second cam follower 548b is in an extended or connecting position where the second electrical connector 334b is positioned to connect to the mobile phone 210, and the first cam follower 548a is in a retracted position where the first electrical connector 334a is not positioned to connect to the mobile phone 210. Referring next to FIG. 9B, further rotation of the camshaft 554 (e.g., in the clockwise direction R) can allow the second cam follower 548b to rotate inwardly, in the direction indicated by the arrow D2, to a second configuration where neither cam follower 548a-b is extended and neither electrical connector 334a-b is positioned to connect to the mobile phone 210. Referring next to FIG. 9C, further rotation of the camshaft 554 can allow the first cam follower 548a to rotate outwardly, in the direction indicated by the arrow D1, to a third configuration where the first electrical connector 334a is positioned to connect to the mobile phone 210.

Referring to FIGS. 9A-9C together, it can be appreciated that rotation of the camshaft 554 can selectively and/or alternatively cycle the cam followers 548a-b and the corresponding electrical connectors 334a-b between extended and retracted positions. Accordingly, and as described previously, the carrier assembly 224 can rotate the camshaft 554 to extend the cam follower and the electrical connector that corresponds to a mobile phone's electrical connector receptacle, based at least in part on information received from the mobile phone 210 regarding a configuration of the mobile phone's electrical connector receptacle.

As those of ordinary skill in the art will appreciate, the foregoing processes are but some examples of ways in which the kiosk 100 can be used to purchase, recycle or otherwise process consumer electronic devices such as mobile phones. Additionally, it should be understood that the configuration of the kiosk 100 described above is but one example of a suitable mobile device evaluation, purchasing, and/or recycling system that can be used with embodiments of the present technology. Accordingly, other embodiments of the present technology can use other systems without departing from the present disclosure. Although the foregoing examples are described in the context of mobile phones, it should be understood that kiosk 100 and various embodiments thereof can also be used in a similar manner for recycling virtually any consumer electronic device, such as MP3 players, tablet computers, laptop computers, e-readers, PDAs, Google® Glass™, smartwatches, and other portable or wearable devices, as well as other relatively non-portable electronic devices such as desktop computers, printers, televisions, DVRs, devices for playing games, entertainment or other digital media on CDs, DVDs, Blu-ray, etc. Moreover, although the foregoing examples are described in the context of use by a consumer, the kiosk 100 in various embodiments thereof can similarly be used by others, such as store clerk, to assist consumers in recycling, selling, exchanging, etc. their electronic devices.

The following patents and patent applications are incorporated herein by reference in their entireties: U.S. Pat. Nos. 10,860,990; 10,853,873; 10,572,946; 10,475,002; 10,445,708; 10,438,174; 10,417,615; 10,401,411; 10,269,110; 10,157,427; 10,127,647; 10,055,798; 9,885,672; 9,881,284; 8,200,533; 8,195,511; and 7,881,965; U.S. patent application Ser. Nos. 17/445,158; 17/445,083; 17/445,082; 17/125,994, 16/794,009; 16/788,169; 16/788,153; 16/719,699; 16/794,009; 16/601,492; 16/575,090; 16/575,003; 16/556,104; 16/556,018; 16/534,741; 16/357,041; 16/195,785; 15/977,729; 15/901,526; 15/855,320; 15/672,157; 15/641,145; 15/630,460; 15/214,791; 15/091,487; 15/057,707; 14/967,183; 14/966,346; 14/964,963; 14/934,134; 14/663,331; 14/660,768; 14/598,469; 14/568,051; 14/498,763; 13/794,816; 13/794,814; 13/753,539; 13/733,984; 13/705,252; 13/693,032; 13/658,828; 13/658,825; 13/492,835; 13/113,497; and U.S. Provisional Application Nos. 63/220,890; 63/220,381; 63/127,148; 63/116,020; 63/116,007; 63/088,377; 63/070,207; 63/066,794; 62/950,075; 62/807,165; 62/807,153; 62/804,714; 62/782,947; 62/782,302; 62/332,736; 62/221,510; 62/202,330; 62/169,072; 62/091,426; 62/090,855; 62/076,437; 62/073,847; 62/073,840; 62/059,132; 62/059,129; 61/607,572; 61/607,548; 61/607,001; 61/606,997; 61/595,154; 61/593,358; 61/583,232; 61/570,309; 61/551,410; 61/472,611; 61/347,635; 61/183,510; and 61/102,304. All the patents and patent applications listed in the preceding sentence and any other patents or patent applications identified herein are incorporated herein by reference in their entireties.

Aspects of the invention can be embodied in a special purpose computer or data processor that is specifically programmed, configured, or constructed to perform one or more of the computer-executable instructions explained in detail herein. While aspects of the present technology, such as certain functions, are described as being performed exclusively on a single device, the present technology can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the present technology may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present technology may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Reference throughout this specification to relative terms such as, for example, “generally,” “approximately,” and “about” are used herein to mean the stated value plus or minus 10%, unless the context clearly requires otherwise.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference in their entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes are at times described as being performed in series, these processes may instead be performed or implemented in parallel or performed at different times.

The teachings of the present technology provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1-23. (canceled)

24. A connector carrier assembly for use with an electronic device recycling kiosk, the connector carrier assembly comprising:
a support structure;
a camshaft rotatably coupled to the support structure and including a cam lobe; and
a cam follower including a proximal end portion pivotally coupled to the support structure and a distal end portion configured to hold an electrical connector,
wherein rotation of the camshaft about a longitudinal axis thereof drives the cam lobe against the cam follower to rotate the distal end portion of the cam follower about the proximal end portion of the cam follower and thereby move the electrical connector relative to the support structure to present the electrical connector for connection to an electronic device.

25. The connector carrier assembly of claim 24 wherein the cam follower includes a bearing surface positioned between the proximal end portion and the distal end portion, and wherein the rotation of the camshaft about the longitudinal axis drives the cam lobe against the bearing surface to rotate the cam follower about the proximal end portion and move the electrical connector away from the support structure.

26. The connector carrier assembly of claim 24, further comprising a biasing member compressed between the cam follower and the support structure to bias the cam follower toward the cam lobe.

27. The connector carrier assembly of claim 24, further comprising a motor fixedly mounted to the support structure, wherein the motor includes an output shaft operably coupled to the camshaft and configured to rotate the camshaft about the longitudinal axis.

28. The connector carrier assembly of claim 24, further comprising the electrical connector, wherein the electrical connector is a mobile phone connector configured to connect to a mobile phone.

29. The connector carrier assembly of claim 24 wherein the cam follower is a first cam follower configured to hold a first electrical connector, wherein the cam lobe is a first cam lobe, and wherein the connector carrier assembly further comprises:
a second cam follower movably coupled to the support structure and operably coupled to a second electrical connector, wherein the camshaft further includes a second cam lobe, and wherein rotation of the camshaft about the longitudinal axis drives the second cam lobe against the second cam follower to thereby move the second electrical connector relative to the support structure.

30. The connector carrier assembly of claim 29 wherein the first and second cam lobes are diametrically opposed about the longitudinal axis.

31. The connector carrier assembly of claim 24, further comprising a biasing element positioned to act on the cam follower and bias the cam follower toward a first direction, wherein the rotation of the camshaft moves the cam follower in a second, opposite direction, and wherein the biasing element includes a compression spring, a tension spring, and/or a torsion spring.

32. The connector carrier assembly of claim 24 wherein the distal end portion of the cam follower defines an aperture sized to receive at least a portion of the electrical connector.

33. A kiosk for purchasing mobile phones from users, the kiosk comprising:
an inspection area having an inspection tray configured to receive a mobile phone; and
a connector carrier assembly positioned proximate the inspection tray, the connector carrier assembly including—
a support structure;
a camshaft rotatably coupled to the support structure and including a cam lobe; and
a cam follower including a proximal end portion pivotally coupled to the support structure and a distal end portion configured to hold an electrical connector,
wherein rotation of the camshaft about a longitudinal axis thereof drives the cam lobe against the cam follower to rotate the distal end portion of the cam follower about the proximal end portion of the cam follower and thereby move the electrical connector relative to the support structure to present the electrical connector for connection to an electronic device.

34. The kiosk of claim 33 wherein the distal end portion of the cam follower defines an aperture sized to receive at least a portion of the electrical connector.

35. The kiosk of claim 33 wherein the cam follower includes a bearing surface positioned between the proximal end portion and the distal end portion, and wherein the rotation of the camshaft about the longitudinal axis drives the cam lobe against the bearing surface to rotate the cam follower about the proximal end portion and move the electrical connector away from the support structure.

36. The kiosk of claim 33, further comprising a motor fixedly mounted to the support structure, wherein the motor includes an output shaft operably coupled to the camshaft and configured to rotate the camshaft about the longitudinal axis.

37. The kiosk of claim 33, further comprising a biasing member compressed between the cam follower and the support structure to bias the cam follower toward the cam lobe.

38. The kiosk of claim 33, further comprising the electrical connector, wherein the electrical connector is a mobile phone connector configured to connect to a mobile phone.

39. A method for operating a kiosk, the method comprising:
receiving information that corresponds to a configuration of an electrical connector receptacle of an electronic device;
identifying an electrical connector of a connector carrier assembly, the electrical connector configured to be releasably received by the electrical connector receptacle;
rotating a camshaft of the connector carrier assembly to drive a cam lobe of the camshaft against a cam follower of the connector carrier assembly, the cam follower including a first end portion and a second end portion, the first end portion including the identified electrical connector and the second end portion pivotally coupled to the support structure; and
pivoting the first end portion of the cam follower about the second end portion of the cam follower and relative to the support structure to extend the electrical connector for connection to the electronic device.

40. The method of claim 39 wherein pivoting the first end portion of the cam follower includes extending the electrical connector at least partially through an opening in an inspection tray of the kiosk.

41. The method of claim 39, further comprising:
prompting, via a display of the kiosk, a user of the kiosk to connect the electronic device to the kiosk via the identified electrical connector; and
when the electrical connector is connected to the electronic device, rotating the camshaft such that a biasing element operably coupled to the cam follower drives the identified electrical connector away from the electronic device to disconnect the electrical connector from the electronic device.

42. The method of claim 39 wherein identifying the electrical connector includes selecting, based on the received information, one of a plurality of electrical connectors.

43. The method of claim 39 wherein receiving the information that corresponds to the configuration of the electrical connector receptacle includes receiving information from a wireless charger of the kiosk and/or receiving, in response to a request, the information from a user of the kiosk.
